(19) United States
(12) Patent Application Publication
(10) Pub. No.: US 2020/0284009 A1
(43) Pub. Date: Sep. 10, 2020

(54) HOSE

(71) Applicant: Xiamen Delmei Sanitary Ware Co., Ltd., Xiamen (CN)

(72) Inventors: Changzheng NI, Xiamen (CN); Yongqiang YAN, Xiamen (CN)

(73) Assignee: Xiamen Delmei Sanitary Ware Co., Ltd., Xiamen (CN)

(21) Appl. No.: 16/810,870

(22) Filed: Mar. 6, 2020

(30) Foreign Application Priority Data
Mar. 8, 2019 (CN) 201920297680.6

(51) Int. Cl. E03C 1/05

(52) U.S. Cl. CPC E03C 1/057; G01K 3/005; E03C 2201/00

(57) ABSTRACT

A hose includes a hose body provided with a first water passage, a connecting assembly connected to the hose body and provided with a second water passage communicating with the first water passage and a light transmitting portion, a temperature-sensitive light-emitting assembly mounted in the second water passage and a hydro-generator, a temperature sensor and an LED light, wherein the hydro-generator powers the temperature sensor and the LED light, the temperature sensor senses a water temperature, and the LED light emits light when the water temperature reaches a threshold, an impeller fixedly connected to a rotor of the hydro-generator and facing a water inlet direction, and a flow guiding base mounted in the second water passage and provided with a baffle, and the baffle is provided with a spiral-shaped water passing hole for water flowing through so as to drive the impeller to rotate.

### CROSS-REFERENCE TO RELATED APPLICATION

This application claims the priority benefit of China application serial no. 201920297680.6, filed on Mar. 8, 2019. The entirety of the above-mentioned patent application is hereby incorporated by reference herein and made a part of this specification.

### BACKGROUND

### Technical Field

The disclosure relates to the field of hoses for shower equipment, in particular, to a hose.

### Description of Related Art

At present, in order to realize a function of indicating the water temperature, a common practice is to add a temperature-sensitive light-emitting device to the faucet or shower. Since the faucet or shower is a water outlet structure, the time for the user to make adjustments to the operation after the temperature is observed is quite short, problems that affect users' experience and safety when the water temperature is too cold or too hot still exist. In addition, the problem of frequent replacement of faucets and showers will also lead to higher maintenance costs for faucets and showers that are equipped with temperature-sensitive light-emitting devices. And also, the commonly used temperature-sensitive light-emitting devices powered by hydroelectric power often require a relatively stable and fast water flow. Therefore, the waste of water is more serious, and the insufficient actuation caused by small water flow cannot provide hydropower generation.

### SUMMARY

The purpose of the disclosure is to provide a hose that has a function of early warning for water temperature, and also has a function of driving power generation while saving water.

To achieve the above object, the following technical solutions are adopted:

A hose, including: a hose body, provided with a first water passage; a connecting assembly, connected to the hose body and provided with a second water passage communicating with the first water passage, the connecting assembly being further provided with a light transmitting portion; a temperature-sensitive light-emitting assembly, mounted in the second water passage, including a hydro-generator, a temperature sensor and an LED light, wherein the hydro-generator powers the temperature sensor and the LED light, the temperature sensor senses a water temperature, and the LED light is mounted corresponding to the light transmitting portion and emits light when the water temperature reaches a threshold; an impeller, fixedly connected to a rotor of the hydro-generator and facing a water inlet direction; and a flow guiding base, mounted in the second water passage and provided with a baffle, wherein the baffle is located in the water inlet direction of the impeller, and the baffle is provided with a spiral-shaped water passing hole; the water ejects out through the spiral-shaped water passing hole to drive the impeller to rotate.

Further, the connecting assembly comprises a first connecting member, a second connecting member, and a third connecting member; the first connecting member, inserted into the hose body and fixedly connected to the hose body, is provided with a flange; the second connecting member is sleeved on the first connecting member, and is prevented from being disengaged with the first connecting member by the flange; the third connecting member is in screw connection with the second connecting member, and provided with the light transmitting portion.

Further, an inner wall of the second connecting member is provided with a first limiting portion, and an inner wall of the third connecting member is provided with a second limiting portion; a chamber is formed between the first limiting portion and the second limiting portion, the temperature-sensitive light-emitting assembly is mounted in the chamber, and a gap is formed between an inner wall of the chamber and the temperature-sensitive light-emitting assembly for the water to pass through.

Compared with the prior art, the above solutions have the following beneficial effects:

First, the hose in this technical solution may provide early warning for the water temperature of the water outlet structure such as a faucet and a shower, such that users could make timely water temperature adjustments, thereby improving use security and improving user experience; the frequency of replacement, the maintenance cost and the difficulty of maintenance for the joints in the hose are low. Therefore, the maintenance cost of the hose with temperature-sensitive light-emitting function is low.

Second, the cross-sectional area of the water inlet is reduced because of the spiral-shaped water passing hole on the flow guiding base, so that the water flow velocity is increased, and the function of driving the impeller to rotate with a small water flow is realized; the water passing hole is spirally configured to reduce the water loss in other directions except in the rotation direction of the impeller, and the driving effect is more reliable.

Third, the second connecting member is limited on the hose body by the flange after the first connecting member is fixedly connected to the hose body, so that the structure is simple, and the assembly is facilitated; the third connecting member is provided with the light transmitting portion, so that a light transmitting function on the connecting assembly may be achieved, and the third connecting member is screwed onto the second connecting member for achieving good replaceability.

Fourth, when the second connecting member and the third connecting member are connected in position the chamber defined by the first limiting portion and the second limiting portion confines the temperature-sensing light-emitting component within it, so as to ensure the structural stability of the temperature-sensitive light-emitting assembly in the connecting assembly.

### BRIEF DESCRIPTION OF THE DRAWINGS

In order to more clearly illustrate the technical solutions in the embodiments of the present disclosure, the drawings used in the description of the embodiments will be briefly described below.

FIG. 1 is a structural diagram of an embodiment of the disclosure.

FIG. 2 is an exploded perspective diagram of an embodiment of the disclosure.

FIG. 3 is a cross-sectional diagram of an embodiment of the disclosure.

FIG. 4 is a structural diagram of a flow guiding base of an embodiment of the disclosure.

FIG. 5 is a structural diagram of a temperature-sensing light-emitting assembly of an embodiment of the disclosure.

FIG. 6 is a circuit diagram of a temperature-sensing light-emitting assembly of an embodiment of the disclosure while sensing temperature and emitting light.

### DESCRIPTION OF THE EMBODIMENTS

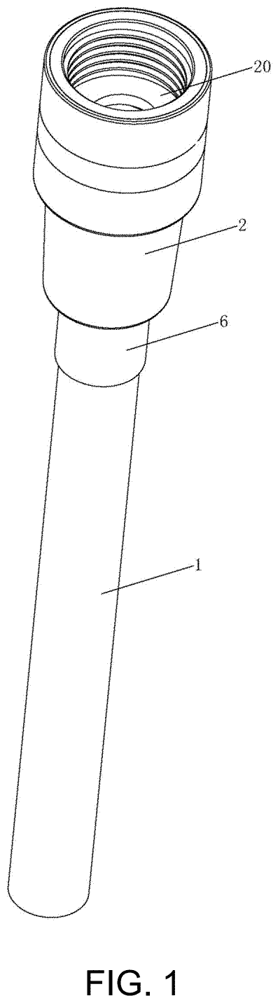

With reference to FIGS. 1 to 5, FIGS. 1 to 5 show structural diagrams of a hose of an embodiment of the disclosure. As shown in FIGS. 1 to 5, in an embodiment of the disclosure, the hose includes a hose body 1, a connecting assembly 2, a temperature-sensitive light-emitting assembly 3, an impeller 4 and a flow guiding base 5.

The hose body 1 is provided inside with a first water passage 10.

The connecting assembly 2 is connected to one end or both ends of the hose body 1 and is provided inside with a second water passage 20 communicating with the first water passage 10, and the connecting assembly 2 is provided with a light transmitting portion 231.

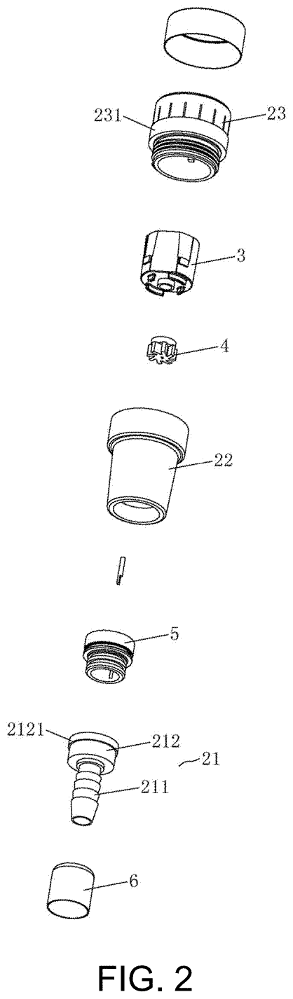

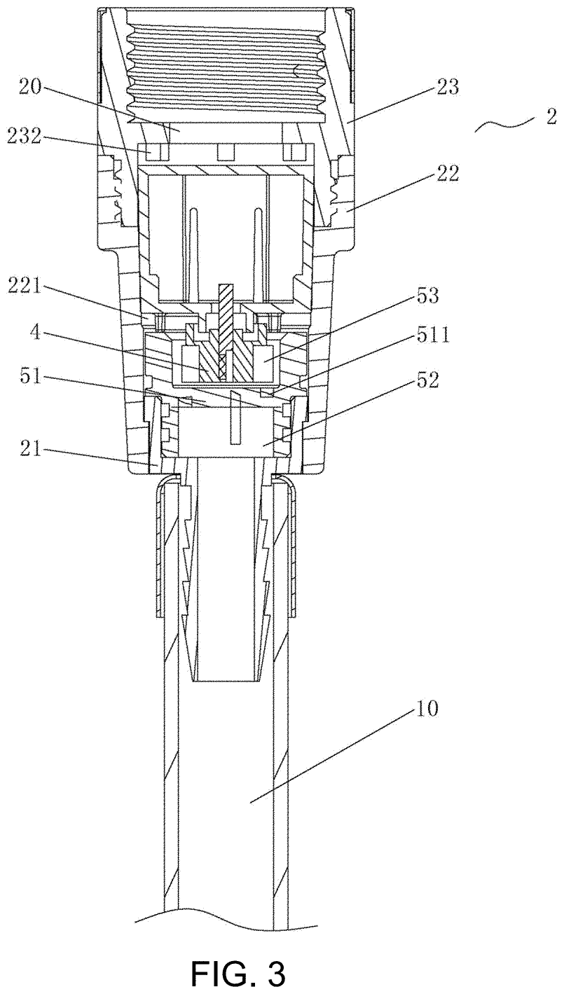

Specifically, as shown in FIGS. 2 and 3, the connecting assembly 2 includes a first connecting member 21, a second connecting member 22 and a third connecting member 23.

The first connecting member 21 is inserted into the hose body 1 and fixedly connected to the hose body 1, and the first connecting member 21 is provided with a flange 2121; specifically, the first connecting member 21 includes an inserting portion 211 and a limiting portion 212 that are connected with each other integrally, and the inserting portion 211 and the limiting portion 212 are provided inside with first through holes that are communicated with each other; the inserting portion 211 is tightly inserted into the hose body 1 so as to fixedly connected to the hose body 1, and preferably, an outer wall of the inserting portion 211 is provided with a barb structure capable of preventing the inserting portion 211 departing from the hose body 1; the limiting portion 212 extends through the hose body 1, and has an outer wall provided with the flange 2121.

The second connecting member 22 is a tubular structure, which is sleeved on the first connecting member 21, and an inner wall of the second connecting member 22 is provided with a limiting surface abutting against the flange 2121 for preventing the second connecting member 22 departing from the first connecting member 21 by the flange 2121; during assembly, the second connecting member 22 is sleeved on the first connecting member 21, and then the inserting portion 211 on the first connecting member 21 is fixedly inserted into the hose body 1, so that the second connecting member 22 could not be detached from the hose body 1 due to the flange 2121, thereby simplifying the structure and facilitating the assembly; in addition, the inner wall of the second connecting member 22 is further provided with a first limiting portion 221, and the first limiting portion 221 is formed by a first bump formed on the inner wall of the second connecting member 22.

The third connecting member 23 is screwed to the second connecting member 22 and is provided with the light transmitting portion 231, and an inner wall of the third connecting member 23 is provided with a second limiting portion 232, thereby good replaceability could be ensured due to the screw connection. Specifically, the third connecting member 23 is also a tubular structure, with one end screwed to the other end of the second connecting member 22 and the other end provided with internal threads, which are used to be connected externally to a water outlet structure or a water supply structure, wherein the third connecting member 23 is made of light transmitting material to ensure the light transmitting function of the light transmitting portion 231. Specifically, a middle portion of the third connecting member 23 is exposed to form the light transmitting portion 231, and an outer side wall of a portion of the third connecting member 23 adjacent to the light transmitting portion 231 is provided with a decorative ferrule to form a decorative portion; an inner wall of the third connecting member 23 is provided with an annular flange, a side of the annular flange facing the second connecting member 22 is provided with a plurality of circumferentially-disposed second bumps, and the second bumps form the second limiting portion 232; the second water passage 20 defines a chamber between the second limiting portion 232 and the first limiting portion 221, and the chamber is used for accommodating the temperature-sensitive light-emitting assembly 3 to ensure the structural stability of the temperature-sensitive light-emitting assembly 3 while being mounted in the connecting assembly 2. The third connecting member 23 is suitable for being screwed to the water outlet structure (such as a shower or a water nozzle), which simplifies the structure and facilitates the disassembly.

It should be noted that the first through holes in the first connecting member 21, the through holes in the second connecting member 22 and the through holes in the third connecting member 23 are communicated tightly in sequence to form the second water passage 20.

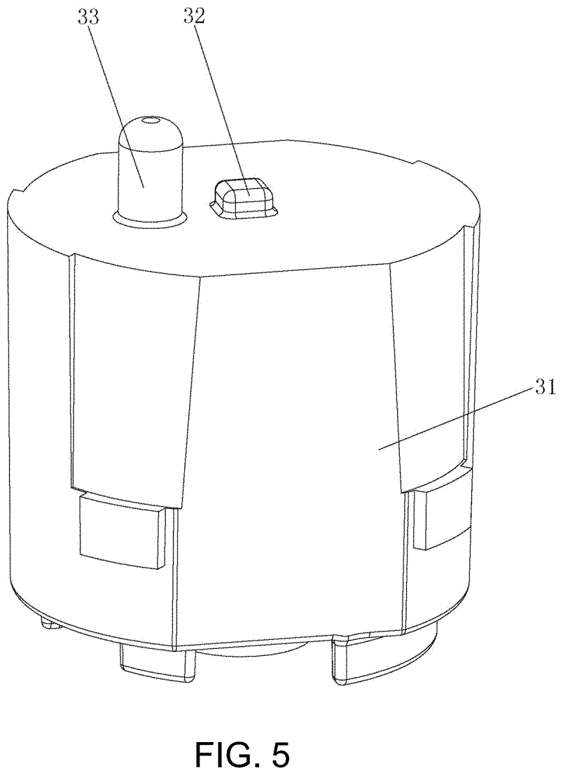

As shown in FIG. 3, the temperature-sensitive light-emitting assembly 3 is mounted in the second water passage 20, specifically, in the chamber defined between the first limiting portion 221 and the second limiting portion 232, and when the temperature-sensitive light-emitting assembly 3 is mounted in the chamber in position, a gap is formed between an inner wall of the chamber and the temperature-sensitive light-emitting assembly 3 for the flow to pass through. As shown in FIG. 5, the temperature-sensitive light-emitting assembly 3 includes a hydro-generator 31, a temperature sensor 32 and an LED light 33, wherein the hydro-generator 31 powers the temperature sensor 32 and the LED light 33, the temperature sensor 32 senses a water temperature, and the LED light 33 is mounted corresponding to the light transmitting portion 231 and emits light when the water temperature reaches a threshold.

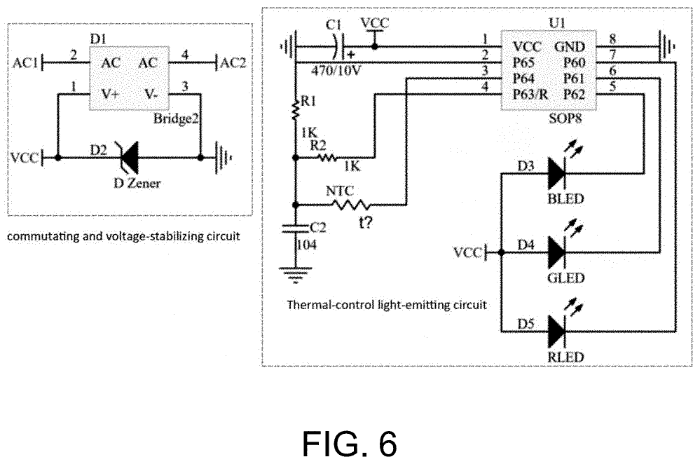

Preferably, the hydro-generator 31, the temperature sensor 32 and the LED light 33 in the present embodiment are encapsulated as a whole, so that the tightness and integrity are better. The temperature sensor 32 and the LED light 33 are disposed on one end of the hydro-generator 31 toward the second limiting portion 232, and the LED light 33 is a tri-color light; a rotation shaft fixedly connected to a rotor is extended from the other end of the hydro-generator 31, and is non-rotatably connected to the impeller 4, and the impeller 4 faces the water inlet direction, so that when in operation, the impeller 4 is rotated under the action of the water flow, the hydro-generator 31 generates electricity to power the temperature sensor 32 and the LED light 33, the temperature sensor 32 senses a water temperature in the second water passage 20, and the LED light 33 displays different colors according to different thresholds of the water temperature, wherein specifically, the LED light 33 is green when the temperature sensor 32 detects that the water temperature in the second water passage 20 is lower than 32° C., the LED light 33 is blue when the temperature sensor 32 detects that the water temperature in the second water passage 20 is between 32-42° C., and the LED light 33 is red when the temperature sensor 32 detects that the water temperature in the second water passage 20 is greater than 42° C., so as to warn the user for preventing the user from getting burned or cold. Specifically, the temperature sensor 32 transmits temperature information to a control chip, and the control chip controls the LED light to emit light of a corresponding color, with a specific circuit diagram shown in FIG. 6, wherein a Commutating and voltage-stabilizing circuit is used to convert AC power to DC power for powering the chip U1, and in the Commutating and voltage-stabilizing circuit, a pin 1 of a rectifier bridge D1 is connected to a cathode of zener diode D2, a pin 3 of the rectifier bridge D1 is connected to an anode of the zener diode D2, a pin 2 of the rectifier bridge D1 is connected to an AC power source AC1, and a pin 4 of the rectifier bridge D1 is connected to an AC power AC2; in the temperature-sensitive light-emitting circuit, a thermistor NTC is used to sense the water temperature, which is connected to pin 3 of the chip U1 so as to transmit a temperature signal to the chip U1; pins 5, 6, and 7 of the chip U1 are connected to light-emitting diode D3, light-emitting diode D4, and light-emitting diode D5 respectively, so as to control one of the light-emitting diode BLED, the light-emitting diode GLED, and the light-emitting diode RLED to emit light according to the temperature information. In the present embodiment, the model of the chip U1 is SSU2C509.

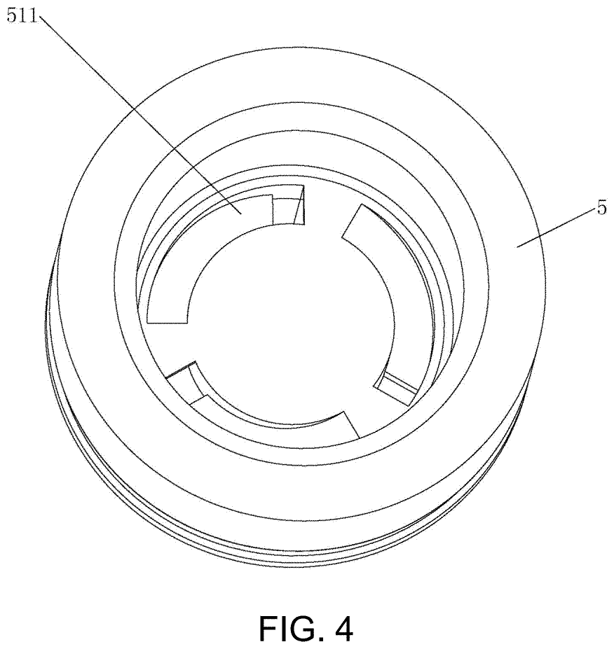

As shown in FIGS. 3 and 4, the flow guiding base 5 is mounted in the second water passage 20, and is provided with a baffle 51; the baffle 51 is located in a water inlet direction of the impeller 4, and the baffle 51 is provided with a spiral-shaped water passing hole 511, so that the water flow ejects out from the spiral-shaped water passing hole 511 to drive the impeller 4 to rotate, the cross section area of water inlet is reduced due to the spiral-shaped water passing hole 511 on the flow guiding base 5, thus the velocity of the water flow is increased, and the water flow ejected from the spiral-shaped water passing hole 511 with greater flow velocity is achieved for driving the impeller 4 to rotate. Therefore, driving the impeller 4 to rotate with a small water flow is achieved, thus minimizing the water loss and making the driving function reliable. Specifically, the flow guiding base 5 is divided into two chambers by the baffle 51, namely a water inlet chamber 52 connected to a water inlet end and a water outlet chamber 53 for receiving the impeller 4; the water inlet chamber 52, the spiral-shaped water passing hole 511, and the water outlet chamber 53 communicate with each other in sequence to form a part of the second water passage 20. In the present embodiment, the flow guiding base 5 is disposed between the first connecting member 21 and the temperature-sensitive light-emitting assembly 3, and an outer wall of the flow guiding base 5 is formed with a stepped surface abutting against an end surface of one end of the first connecting member 21 that extends into the second connecting member 22, and one side of the flow guiding base 5 provided with the water inlet chamber 52 extends into the first through hole with an outer wall sealingly matched with a wall of the first through hole. One side of the flow guiding base 5 provided with the water outlet chamber 53 is located in the through hole of the second connecting member 22 with an outer wall sealingly fitted with a wall of the through hole of the second connecting member 22. The sealing effect achieved by the sealing cooperation ensures that the water flowing through the flow guiding base 5 could only flow through the water inlet chamber 52, the spiral-shaped water passing hole 511 and the water outlet chamber 53, so as to avoid the loss in the velocity of the water flow.

Preferably, in the present embodiment, an outer wall of one side of the hose body 1 connected to the connecting assembly 2 is sleeved with a decorative ring 6, one end of the decorative ring is formed with a bending portion, and the bending portion is abutted between the limiting portion 212 and an end surface of the hose body 1.

In actual use, as described above, the decorative ring is sleeved on the hose body 1, and after the second connecting member 22 is sleeved on the first connecting member 21, the inserting portion 211 on the first connecting member 21 is fixedly inserted into the hose body 1; and then the flow guiding base 5 is mounted sealingly, the water inlet chamber 52 of the flow guiding base 5 cooperates sealingly with an inner wall of the through hole in the limiting portion 212 while the water outlet chamber 53 communicates sealingly with the through hole in the second connecting member 22; the impeller 4 is placed into the water inlet chamber 53 of the flow guiding base 5 after being non-rotatably fixedly connected to the rotation shaft of the temperature-sensitive light-emitting assembly 3; and then, the third connecting member 23 is screwed to the second connecting member 22 to complete assembly. When the water passes through, the water flow ejects out through the spiral-shaped water passing hole 511 and drives the impeller 4 to rotate, the impeller 4 drives the rotor to rotate such that the hydro-generator 31 generates electricity, the hydro-generator 31 powers the temperature sensor 32 and the LED light 33, and the temperature sensor 32 senses the water temperature in the second water passage 20, so that the LED light 33 could display colors according to the water temperature and serve as a warning.

The hose in the present embodiment may provide a early warning as for the water temperature of the water outlet structure such as a faucet and a shower, such that users could make timely water temperature adjustments, thereby improving use security and reducing the maintenance cost.

The foregoing description and description of the embodiments are used to explain the disclosure, but do not constitute a limitation on the protection scope of the disclosure.

What is claimed is:

1. A hose, comprising:
a hose body, provided with a first water passage;
a connecting assembly, connected to the hose body and provided with a second water passage communicating with the first water passage, the connecting assembly being further provided with a light transmitting portion;
a temperature-sensitive light-emitting assembly, mounted in the second water passage, including a hydro-generator, a temperature sensor and an LED light, wherein the hydro-generator powers the temperature sensor and the LED light, the temperature sensor senses a water temperature, and the LED light is mounted corresponding to the light transmitting portion and emits light when the water temperature reaches a threshold;
an impeller, fixedly connected to a rotor of the hydro-generator and facing a water inlet direction; and
a flow guiding base, mounted in the second water passage and provided with a baffle, wherein the baffle is located in the water inlet direction of the impeller, and the baffle is provided with a spiral-shaped water passing hole, and the water ejects out through the spiral-shaped water passing hole to drive the impeller to rotate.

2. The hose according to claim 1, wherein the connecting assembly comprises a first connecting member, a second connecting member, and a third connecting member;
the first connecting member, inserted into the hose body and fixedly connected to the hose body, is provided with a flange;
the second connecting member is sleeved on the first connecting member, and is prevented from being disengaged with the first connecting member by the flange; and
the third connecting member is in screw connection with the second connecting member, and provided with the light transmitting portion.

3. The hose according to claim 2, wherein an inner wall of the second connecting member is provided with a first limiting portion, and an inner wall of the third connecting member is provided with a second limiting portion; a chamber is formed between the first limiting portion and the second limiting portion, the temperature-sensitive light-emitting assembly is mounted in the chamber, and a gap is formed between an inner wall of the chamber and the temperature-sensitive light-emitting assembly for the water to pass through.
